(19) United States
(12) Patent Application Publication
(10) Pub. No.: US 2008/0165394 A1
(43) Pub. Date: Jul. 10, 2008

(54) SCANNING DEVICE

(75) Inventors: Chien-Hsing Tang, Taipei City (TW); Huai-Wen Hsu, Taipei City (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 11/967,611

(22) Filed: Dec. 31, 2007

(30) Foreign Application Priority Data
Jan. 4, 2007 (TW) TW96100296

(51) Int. Cl. H04N 1/04

(52) U.S. Cl. 358/487; 358/498

(57) ABSTRACT

A scanning device includes a housing, a transparent plate, an document feeder and an image capture module. The housing has an opening and the transparent plate covers the opening. The transparent plate has a stripe area, a first side neighboring to the stripe area, and a second side. The document feeder has an aperture. The image capture module, capable to move below the transparent plate, has a first scanning origin corresponding to the stripe area, and a second scanning origin corresponding to the second side. When the object is placed on the transparent plate, the image capture module moves from the second scanning origin toward the stripe area to scan the object. When the object is placed on the document feeder, the object is transported to pass the first scanning origin, and the image capture module is simultaneously positioned below the stripe area to scan the object through the aperture.

### BACKGROUND OF THE INVENTION

1. Field of the Invention

The invention relates to a scanning device, in particular, to a scanning device with an document feeder.

2. Description of the Related Art

Referring to FIG. 1, a conventional scanner 1 comprises a transparent platform E and an image capture module C disposed therebelow, capturing images of the document placed on the transparent platform E. Additionally, an document feeder F is provided to guide the document from a paper inlet I automatically. The document enters a scanning area A of the document feeder F, and exits to a paper outlet O. When scanning, the image capture module C moves to the scanning area A. Because the scanning area A has a transparent subwindow S, the image capture module C captures the image of the document through the scanning platform E and the subwindow S when the document passes by the scanning area A.

The subwindow is usually glass, requiring high manufacturing cost. Another conventional scanner substitutes Mylar; however, Mylar is easily worn and requires replacement.

### BRIEF SUMMARY OF THE INVENTION

The invention provides a scanning device for scanning an object. The scanning device includes a housing, a transparent plate, an document feeder and an image capture module. The housing has an opening and the transparent plate covers the opening. The transparent plate has a stripe area, a first side and a second side. The stripe area neighbors to the first side of the transparent plate. The document feeder is disposed above the transparent plate, having an aperture facing the strip area. The image capture module is capable to move below the transparent plate, having a first scanning origin and the second scanning origin. The first scanning origin corresponds to the stripe area and the second scanning origin corresponds to the second side of the transparent plate. When the object is placed on the transparent plate, the image capture module moves from the second scanning origin toward the stripe area to scan the object placed on the transparent plate. When the object is placed on the document feeder, the object is transported to pass the first scanning origin, and the image capture module is simultaneously positioned below the stripe area to scan the object through the aperture.

The invention provides another scanning device. The scanning device comprises a housing, a transparent plate, a document feeder and an image capture module. The housing has an opening. The transparent plate, disposed within the opening, comprises a first scanning origin and second scanning origin. The first scanning origin is located at where the transparent plate contacts the housing, and the first scanning origin and the second scanning origin is located at different positions of the transparent plate. The document feeder, disposed above the transparent plate, has an aperture facing the first scanning origin. The image capture module is capable to move below the transparent plate. When the object is placed on the transparent plate, the image capture module moves from the second scanning origin along the transparent plate to scan the objected placed on the transparent plate. When the object is placed on the document feeder, the object is transported to pass the first scanning origin, and the image capture module is simultaneously positioned below the first scanning origin to scan the object passing the first scanning origin.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional scanner;

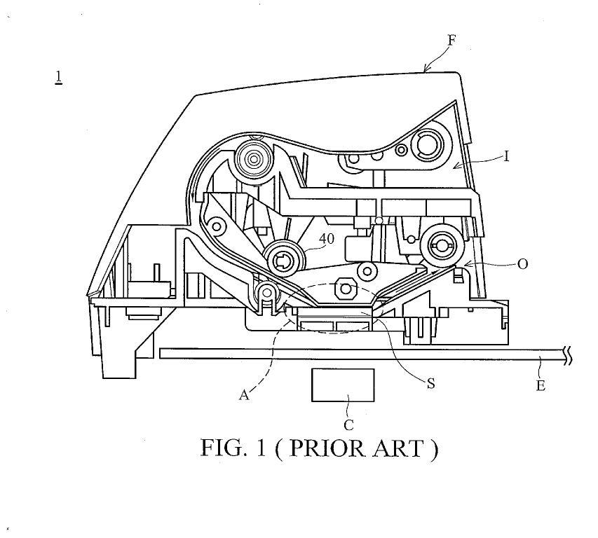

FIG. 2A is a sectional view of an document feeder of a scanning device of the invention;

FIG. 2B is a sectional view of a portion of the scanning device of the invention;

FIG. 2C is a sectional view of the scanning device of the invention showing a image capture module in a first position, scanning an object through a transparent plate and an aperture;

FIG. 2D is a sectional view of the scanning device of the invention showing the image capture module moving between the first position and a second position, scanning the object placed on the transparent plate;

FIG. 3A is a top view of the scanning device of the invention without the document feeder;

FIG. 3B is a top view of the scanning device of the invention; and

FIG. 3C is a top view of the scanning device of the invention.

### DETAILED DESCRIPTION OF THE INVENTION

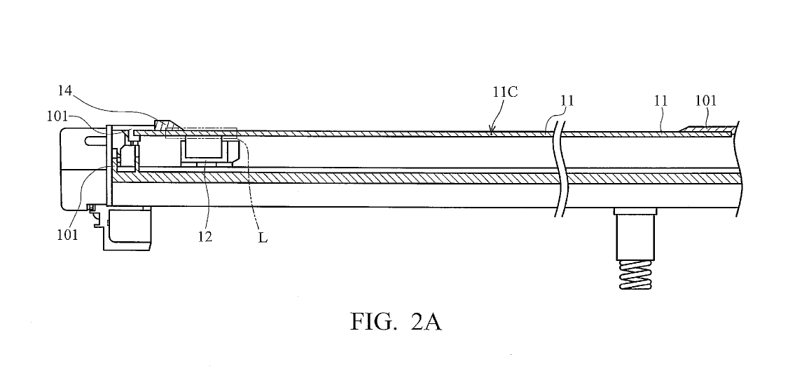

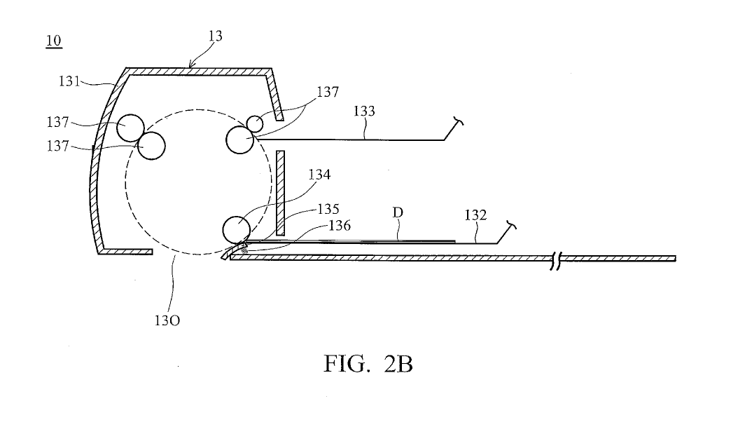

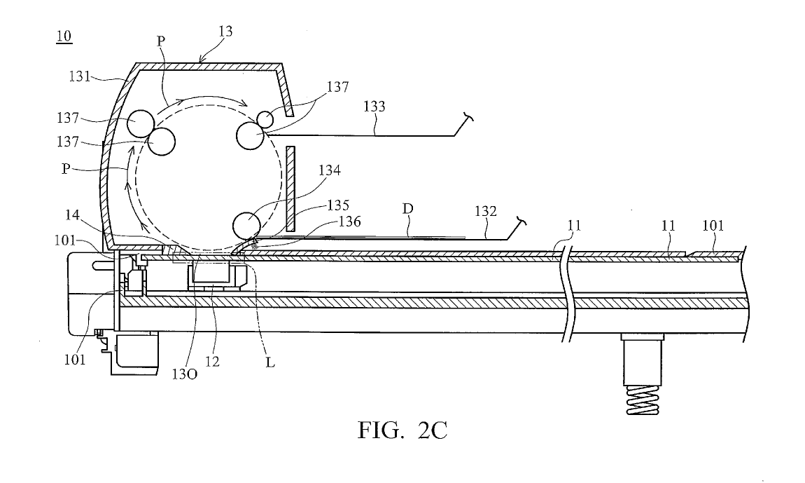

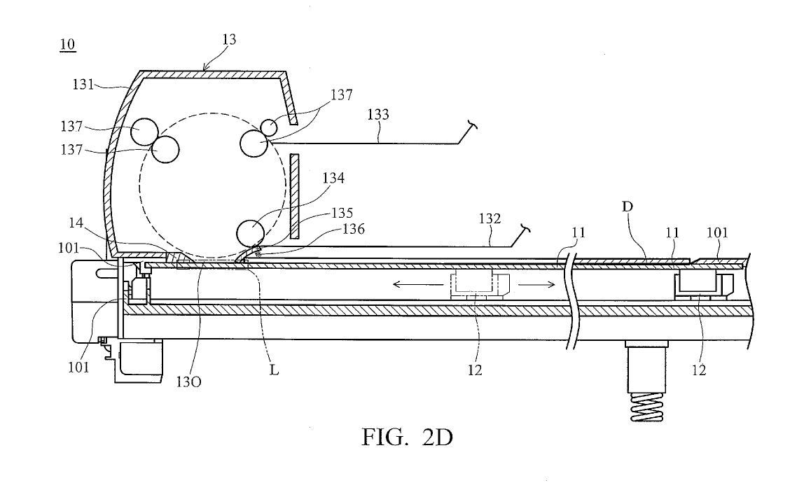

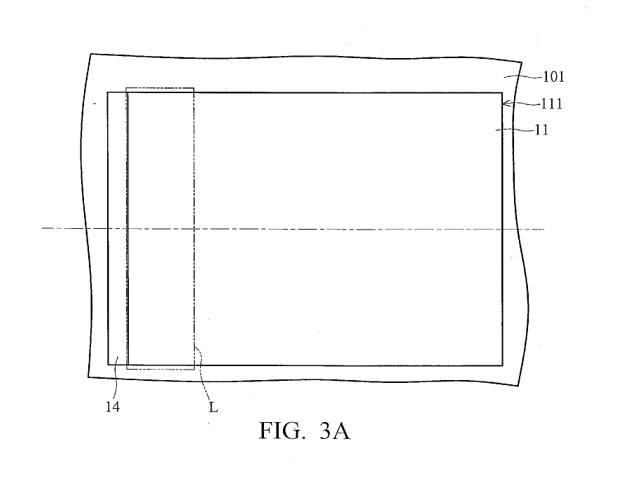

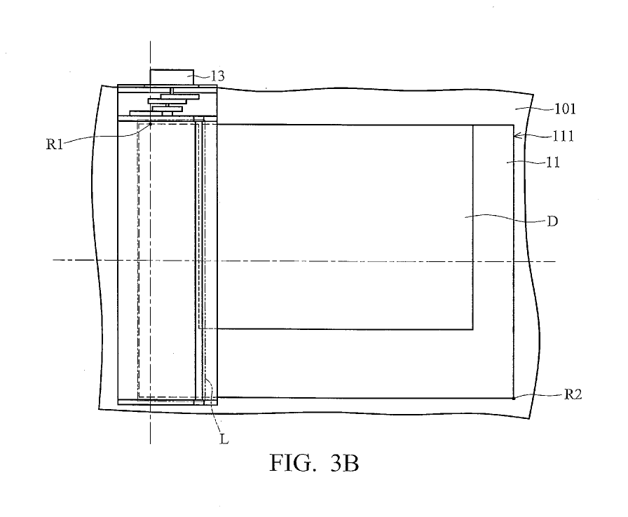

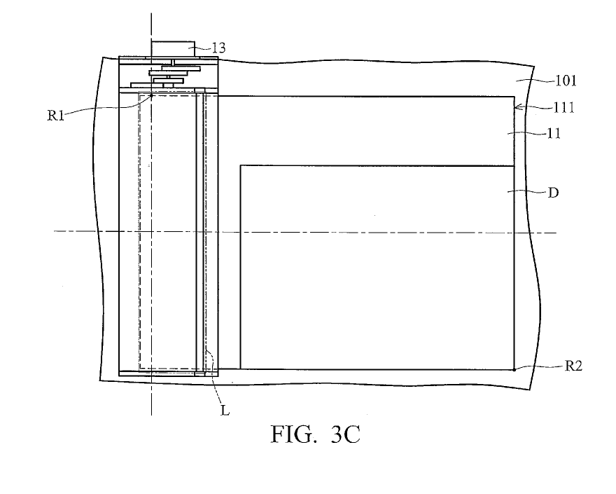

Referring to FIGS. 2A to 2D and FIG. 3A, the scanning device 10 comprises a housing 101, a transparent plate 11, an image capture module 12, an document feeder 13 and a guiding member 14, wherein the housing comprises an opening. The transparent plate 11, disposed within the opening, has a scanning area 111 (as shown in FIGS. 3A and 3B). The transparent plate 11 has a center 11C and a stripe area L adjacent to the housing 101. The image capture module 12 is disposed under the transparent plate 11, capable to move below the transparent plate 11, and the document feeder 13 is disposed above the transparent plate 11. The guiding member 14 is disposed on the housing 101, neighboring to the stripe area L, wherein an obtuse angle is formed between the guiding member 14 and the transparent plate 11. Additionally, the distance between the guiding member 14 and the center 11C being longer than the distance between the stripe area L and the center 11C. An object can be placed on the transparent plate 11 to be scanned, or placed in the document feeder 13 to be scanned through the scanning area 111 automatically.

Referring to FIGS. 3A and 3B, the image capture module 12 scans images by a charged couple device (CCD) or a contact image sensor (CIS). Additionally, the image capture module 12 moves between a first position (as shown in FIG. 2A) and a second position (as shown in FIG. 2B) relative to the transparent plate 11, scanning the object in the scanning area 111. When the image capture module 12 is in the first position, the image capture module 12 has a first scanning origin R1, in the stripe area L, corresponding to a corner of the scanning area 111. When the image capture module 12 is in the second position, the image capture module 12 has a second scanning origin R2, corresponding to another corner of the scanning area 112, and diagonal to the first scanning origin R1.

Referring to FIGS. 2A to 2D again, the document feeder 13 comprises a casing 131, a paper inlet 132 (bottom plate), a paper outlet 133 (upper plate), a feeding roller 134, a dividing member 135, an elastic member 136 and a plurality of rollers 137. The casing 131 has an aperture 13O corresponding to the image capture module 12. The paper inlet 132 is disposed outside the casing 131, and the paper outlet 133 is also disposed outside the casing 131 and above the paper inlet 132. The feeding roller 134, rotating clockwise, is disposed in the casing 131. The dividing member 135 is disposed in the casing 131. The elastic member 136, a compression spring or a torsion spring, is disposed between the casing 131 and the dividing member 135, providing elasticity to the dividing member 135, such that the dividing member 135 abuts the feeding roller 134 appropriately. The rollers 137, disposed in the casing 12, are arranged along a path P.

Referring to FIGS. 2C and 3B, the scanning objects D are usually sheets of paper. When scanning with the document feeder 12, the object D is placed on the paper inlet 132 with its recorded image facing down. A side of the object D is aligned with the first scanning origin R1 (as shown in FIG. 3A), and an end of the object D abuts the feeding roller 134 (as shown in 2A). When the feeding roller 134 rotates, the object D is moved thereby, passing through the feeding roller 134 and the dividing member 135. After the object D passes the aperture 13O, the object D contacts the guiding member 14 and is turned by the guiding member 14, allowing the object D to turn inward the document feeder 13. The object D moves along the path P, through the plurality of rollers 136, and is guided out of casing 131, to the paper outlet 133.

As described, the object D passes by the aperture 13O, entering the stripe area L of the scanning area 111. The recorded image of the object D faces the image capture module 12, such that the image capture module 12 captures the image of the object D based on the first scanning origin R1 through the transparent plate 11 and the aperture 13O.

Referring to FIGS. 2D and 3C, when scanning with the transparent plate 11, the object D is place on the transparent plate 11 with the recorded image facing down. The object D is aligned with the second scanning origin R2. The image capture module 12 moves along the transparent plate 11, scanning the image of the object D base on the second scanning origin R2.

The scanning device 10 of the invention improves the design of the conventional document feeder. When scanning the object D with the document feeder 13, the subwindow is eliminated to save manufacturing cost and time. The overall volume of the scanning device 10 is also decreased. Moreover, when the scanning device 10 of the invention scans by platform scanning (by the transparent plate) and automatic scanning (by the document feeder), the image capture module 12 captures images based on different scanning origins (the first scanning origin or the second scanning origin). According to different demand, the document is placed on the transparent plate or the document feeder and scanned based on first or second scanning origins, respectively.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanning device for scanning an object, comprising:
a housing having an opening;
a transparent plate covering the opening, having a stripe area, a first side and a second side, the stripe area neighboring to the first side of the transparent plate;
a document feeder disposed above the transparent plate, having an aperture facing the stripe area; and
an image capture module capable to move below the transparent plate, having a first scanning origin corresponding to the stripe area and a second scanning origin corresponding to the second side of the transparent plate;
wherein when the object is placed on the transparent plate, the image capture module moves from the second scanning origin toward the stripe area to scan the object placed on the transparent plate;
when the object is placed on the document feeder, the object is transported to pass the first scanning origin, and the image capture module is simultaneously positioned below the stripe area to scan the object through the aperture.

2. The scanning device as claimed in claim 1, wherein the image capture module moves between a first position and a second position relative to the transparent plate, and when the image capture module is in the first position, the image capture module corresponds to the aperture, capturing an image of the object passing thereby.

3. The scanning device as claimed in claim 2, wherein the transparent plate comprises a scanning area, when the image capture module is in the first position, the image capture module has the first scanning origin corresponding to a corner of the scanning area.

4. The scanning device as claimed in claim 3, wherein when the image capture module is in the second position, the image capture module has the second scanning origin corresponding to another corner diagonal to the first scanning origin.

5. The scanning device as claimed in claim 1, wherein the scanning device further comprises a guiding member disposed between the document feeder and the housing, and neighboring to the stripe area, and an obtuse angle is formed between the guiding member and the transparent plate.

6. The scanning device as claimed in claim 1, wherein the document feeder comprises a casing, a feeding roller rotatably disposed in the casing, and a dividing member disposed in the casing, abutting the feeding roller.

7. The scanning device as claimed in claim 6, wherein the document feeder further comprises a paper inlet disposed out of the casing, and the object is placed on the paper inlet, abutting the feeding roller.

8. The scanning device as claimed in claim 6, wherein the document feeder further comprises an elastic member disposed on the dividing member, providing elasticity to the dividing member.

9. The scanning device as claimed in claim 1, wherein the document feeder further comprises a plurality of rollers disposed in the casing and arranged along a path, guiding the object out of the casing along the path.

10. The scanning device as claimed in claim 9, wherein the document feeder further comprises a paper outlet disposed out of the casing, and the object is guided to the paper outlet along the path.

11. The scanning device as claimed in claim 1, wherein the object is guided in the document feeder from a bottom plate and out to an upper plate.

12. The scanning device as claimed in claim 1, wherein the scanning device further comprises a guiding member disposed between the document feeder and the housing, and neighboring to the stripe area, and the guiding member is disposed on the housing or on the document feeder.

13. A scanning device for scanning an object, comprising:
a housing having an opening;
a transparent plate disposed within the opening, comprising a first scanning origin and a second scanning origin, the first scanning origin located at where the transparent plate contacts the housing, and the first scanning origin and the second scanning origin being located at different positions of the transparent plate;
a document feeder disposed above the transparent plate, having an aperture facing the first scanning origin; and
an image capture module capable to move below the transparent plate;
wherein when the object is placed on the transparent plate, the image capture module moves from the second scanning origin along the transparent plate to scan the object placed on the transparent plate; and
when the object is placed on the document feeder, the object is transported to pass the first scanning origin, and the image capture module is simultaneously positioned below the first scanning origin to scan the object passing the first scanning origin.

14. The scanning device as claimed in claim 13, further comprising:
an document feeder disposed above the transparent plate, comprising:
a casing having an aperture corresponding to the image capture module;
a feeding roller disposed in the casing;
a dividing member disposed in the casing;
wherein when the feeding roller rotates, the feeding roller brings the object passing between the feeding roller and the dividing member, entering the casing, passing the aperture and out of the casing.

15. The scanning device as claimed in claim 14, wherein the scanning device further comprises a guiding member disposed between the document feeder and the housing, and neighboring to the first scanning origin, and the guiding member turns the object after the object passing the aperture.

16. The scanning device as claimed in claim 15, wherein an obtuse angle is formed between the guiding member and the transparent plate.

17. The scanning device as claimed in claim 13, wherein the transparent plate comprises a scanning area, the first scanning origin corresponds to a corner of the scanning area, the second scanning origin corresponds to another corner diagonal to the first scanning origin.

18. The scanning device as claimed in claim 13, wherein the transparent plate comprises a scanning area, the first scanning origin corresponds to a side of the scanning area, the second scanning origin corresponds to an opposite side of the scanning area.

19. The scanning device as claimed in claim 13, wherein the object is guided in the document feeder from a bottom plate and out to an upper plate.

20. The scanning device as claimed in claim 13, wherein the guiding member is disposed on either one of the housing and the document feeder.
